(19) United States
(12) Patent Application Publication
(10) Pub. No.: US 2023/0263172 A1
(43) Pub. Date: Aug. 24, 2023

(54) RETURNING UNIT FOR FLAT FOOD PRODUCT LIKE PANCAKES

(71) Applicant: ACEMAL INTERNATIONAL, Nothum (LU)

(72) Inventor: Pierre DE LONGRÉE, Nothum (LU)

(21) Appl. No.: 18/017,615

(22) PCT Filed: Jul. 20, 2021
(86) PCT No.: PCT/EP2021/070201

§ 371 Date: Jan. 23, 2023

(30) Foreign Application Priority Data
Jul. 21, 2020 (LU) LU101940

(51) Int. Cl. A21B 3/07; A21C 9/08

(52) U.S. Cl. CPC A21B 3/07; A21C 9/08

(57) ABSTRACT

A unit for returning one or several flat food products, comprising a returning element configured for rotating around a rotating axis and provided with at least one outer face for receiving the one or several flat food products to be returned; wherein the at least one outer face is provided with air aspiration holes for maintaining by depression the one or several flat food products on the outer face when the returning element is rotated with the outer face oriented downwardly.

### CROSS-REFERENCE TO RELATED APPLICATIONS

The present invention is the US national stage under 35 U.S.C. § 371 of International Application No. PCT/EP2021/070201 which was filed on Jul. 20, 2021, and which claims the priority of application LU101940 filed on Jul. 21, 2020 the contents of which (text, drawings and claims) are incorporated here by reference in its entirety.

### FIELD

The invention is directed to the field of production of flat food products which require to be returned during their production, in particular of pancakes requires to be backed on both sides.

### BACKGROUND

Prior art patent document published FR 2 706 164 A1 discloses a unit for returning flat food products like pancakes. The returning unit is installed along a main conveyor with cooking plates. The returning unit is comprised of an entry belt conveyor designed for collecting the pancakes from a main conveyor with baking plates, and of a drum-shaped rotating returning element with a circular outer face for receiving the pancakes from the entry conveyor. Once a pancake is received by the returning element, it conforms to the circular shape of the outer face and naturally adheres thereto. A scraper is provided adjacent to the outer face of the rotating element, at a lower position thereto, configured for taking off the pancake from the outer surface. Because of the rotational speed of the pancake on the returning element that is opposite to the translational speed of the main conveyor with the baking plates, the returning element is mounted in a translational fashion relative to the frame of the main conveyor, in order to be moved in the same direction as the translational movement of the main conveyor. In an alternative embodiment, the drum-shaped returning element is replaced by a second belt conveyor. This teaching is interesting in that it can provide an accurate positioning of the food product on the main conveyor after being returned. The food product can however show a varying adhering behaviour on the outer face of the returning element, i.e., not sufficiently adhere and therefore precociously take off and fall in an uncontrolled manner on the main conveyor, or show difficulties in releasing from the outer surface by the scraper, also leading to a potential fall in an uncontrolled manner on the main conveyor. Also the translational movement of the returning element relative to the frame of the main conveyor requires additional space, complexity and costs.

Prior art patent document published EP 1 759 585 A2 discloses also a unit for returning flat food products like pancakes. The returning unit comprises a flat scraper rotatable around about 180° for first collecting a pancake from a main conveyor, and second rotate for pivoting the pancake of about 180° around the rotation axis and bringing it in a returned state to the main conveyor. That returning unit is advantageous in that it is relatively simple and compact. It however requires fine adjustments in the rotation movements. Also the positioning of the food product, once returned, back on the main conveyor can show some inaccuracies essentially due to the dynamic effects required for maintaining the food product in position against the scraper once raised on falling down to the main conveyor.

Prior art patent document published EP 3 434 160 A1 discloses also a unit for returning flat food products like pancakes. The returning unit is comprised essentially of three rolls arranged after the exit of a belt conveyor, the three rolls showing a reduced diameter and being rotated at a reduced speed to as to allow the flat food product to pivot about the last roll when leaving the returning unit. That returning unit is advantageous in that it can transfer the food product without returning action by rotating the rolls at a higher speed. For a proper returning, it requires however a certain rigidity of the food product, where freshly baked pancakes, for instance only on one side, shows a very limited rigidity, meaning that the returning unit of this teaching might not be adequate.

### SUMMARY

The invention has for technical problem to overcome at least one drawback of the above cited prior art. More specifically, the invention has for technical problem to provide a returning unit for flat food products, like pancakes, that provides an accurate and controlled positioning of the food products once returned.

The invention is directed to a unit for returning one or several flat food products, comprising a returning element configured for rotating around a rotating axis and provided at least one outer face for receiving the one or several flat food products to be returned; wherein the at least one outer face is provided with air aspiration holes for maintaining by depression the one or several flat food products on the outer face when the returning element is rotated with the outer face oriented downwardly.

According to an exemplary embodiment, each of the at least one outer face is flat.

According to an exemplary embodiment, the at least one outer face comprises a first outer face and a second outer face opposed to the first outer surface.

Advantageously, the returning elements shows a cross-section shape that is polygonal, e.g., rectangle or square.

According to an exemplary embodiment, the at least one outer face comprises more than two outer faces distributed around the rotating axis.

According to an exemplary embodiment, the returning element is elongate along the rotating axis and each of the at least one outer face is subdivided in several areas each for receiving one of the several flat food products.

According to an exemplary embodiment, the returning element comprises a specific vacuum chamber in fluid connection with the air aspiration holes for each of the at least one outer face.

According to an exemplary embodiment, the unit further comprises means configured for limiting the vacuum to not more than 50 mbar below atmospheric pressure. These means can comprise a ventilator specifically dimensioned for achieving the vacuum of more than 50 mbar.

According to an exemplary embodiment, the returning element forms a hollow profile extending along the rotation axis and showing a cross-section with at least one outer wall forming the at least one outer face.

According to an exemplary embodiment, the unit further comprises a loading conveyor configured for loading the one or several flat food products on one of the at least one outer face of the returning element.

According to an exemplary embodiment, the loading conveyor is a belt conveyor with a retractable end configured for selectively extending from the belt to bring the one or more flat food products from the belt to one of the at least one outer face of the returning element, and retracting to the belt away from the outer face.

According to an exemplary embodiment, the unit further comprises an unloading conveyor located below the returning element and configured for receiving the one or several flat food products in a returned state.

According to an exemplary embodiment, the unloading conveyor forms a main conveyor extending on an entry side of the unit, the entry conveyor being configured for collecting the one or more flat food products from the main conveyor.

According to an exemplary embodiment, the main conveyor comprises cooking plates attached to each other along a main direction of the main conveyor and configured for receiving, each and along the main direction, one of the flat food products.

According to an exemplary embodiment, the unit further comprises at least one vacuum pump fluidly connected to the air aspiration holes of the at least one outer face of the returning element. The vacuum pump can be a ventilator.

According to an exemplary embodiment, the at least one vacuum pump is fluidly connected to the at least vacuum chamber of the returning element.

According to an exemplary embodiment, the fluid connection of the at least one vacuum pump is angularly fixed relative to the returning element, the returning element being actuated for rotating in a reciprocal manner.

According to an exemplary embodiment, the fluid connection of the at least one vacuum pump is angularly rotatable relative to the returning element, the returning element being actuated for rotating in a same rotational direction.

According to an exemplary embodiment, the fluid connection of the at least one vacuum pump is located at one or two ends of the returning element along the rotation axis.

According to an exemplary embodiment, the unit further comprises a control unit configured for, successively and iteratively, bringing one or several flat food products on one of the at least one outer face of the returning element, applying a depression to the one or several flat food products through the air aspiration holes of the outer face, rotating the returning element so as to return the one or several flat food products, and releasing the depression so that the one or several flat food products separate from the returning element by gravity.

The invention is also directed to a process of returning one or several flat food products, comprising the steps of: (a) loading the one or several flat food products on an outer surface of a returning element; (b) rotating the returning element so as to return the one or several flat food products; and (c) unloading the one or several flat food products from the returning element; wherein step (b) comprises maintaining the one or several flat food products on the outer surface by applying a depression on a lower face of the one or several flat food products via air aspiration holes provided on the outer surface; and step (c) comprises releasing the depression on the one or several flat food products.

According to an exemplary embodiment, step (c) comprises applying compressed air to the air aspiration holes for facilitating releasing of the one or several flat food products from the outer surface.

The invention is particularly interesting in that it provides a better control in the positioning of the returned food product. Accordingly, the production speed can be easily increased. The returning element can indeed be rotated rapidly due to maintaining the food product(s) against the outer face(s) by depression. Also, the unloading of the food product(s) is also better controlled, avoiding the adverse effect of dynamic effects such as in the prior art.

### DRAWINGS

FIG. 1 is an exemplary schematic representation of a production line for baked flat food products like pancakes, equipped with a returning unit according to various embodiments of the invention.

FIG. 2 is an exemplary perspective detail view of a portion of the returning unit, according to various embodiments of the invention.

FIG. 3 exemplarily shows four successive steps of functioning of the returning unit of FIGS. 1 and 2, according to various embodiments of the invention.

FIG. 4 is an exemplary schematic representation of the fluid connection of the returning element to vacuum pumps, according to an exemplary embodiment of the invention.

FIG. 5 is a schematic representation of the fluid connection of the returning element to vacuum pumps, according to an alternative exemplary embodiment the invention.

### DETAILED DESCRIPTION

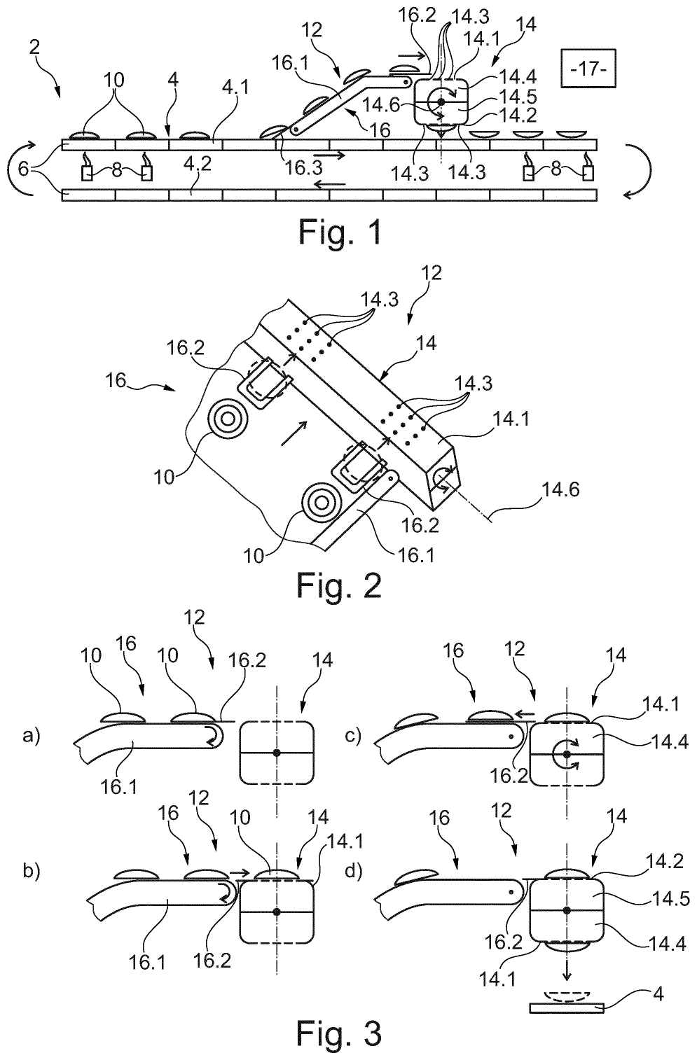

FIG. 1 illustrates in a schematic way a production line of baked flat food products like pancakes. Such products are baked in an open environment (i.e., contrary to an oven) on a baking or cooking hot surface, and this for instance on both sides.

The production line 2 comprises a main conveyor 4 carrying a series of baking plates 6 arranged next to each other along the conveyor. A support chain (not represented) can be provided for supporting the baking plates 6. The support chain and the baking plates form a closed loop with an upper portion 4.1 that for instance moves from left to right and a lower portion 4.2 that for instance moves from right to left. The closed loop rotates at about 180° around two supporting rolls (not represented). A series of burners 8 are provided below the baking plates 6 of the upper portion 4.1 for baking the pancakes 10. The production line 2 comprises also a dough pouring unit (also not represented) at the beginning of the upper portion 4.1 of the main conveyor 4, as such well known to the skilled person.

The production line 4 is equipped with a returning unit 12 of the pancakes 10. The returning unit 12 comprises essentially a returning element 14 showing at least one outer face 14.1 or 14.2 provided with aspiration holes 14.3. For instance the returning element 14 comprises a first outer face 14.1 and a second outer face 14.2 opposed to the first outer face 14.1. The aspiration holes 14.3 provided on the first outer face 14.1 are in direct fluid communication with a first vacuum chamber 14.4 and similarly the aspiration holes 14.3 provided on the second outer face 14.2 are in direct fluid communication with a second vacuum chamber 14.5. These first and second vacuum chambers 14.4 and 14.5 are distinct and not in fluid communication. Each of them is fluidly connected to a corresponding vacuum pump as this will be detailed further below. The returning element 14 is rotatable around a rotation axis 14.6 that extends through a central area of the transversal cross-section of the returning element 14. The vacuum applied to the chamber in fluid connection with the aspiration holes 14.3 allows a flat food product, for instance a pancake, to be maintained against the outer face by depression of its under face contacting the outer face. The food product can be maintained in position during rotating of the returning element 14 until the food product is in a returned and lower position where it can be released from the returning element 14.

The returning unit 12 can also comprise a loading conveyor 16, being for instance of the belt-type. It is shaped and oriented for collecting the food products, for instance the pancakes 10, from the main conveyor 4 and loading them onto the returning element 14, more particularly on one of the at least one outer face 14.1 and 14.2. The loading conveyor 16 can comprise a belt conveyor 16.1, of a well-known construction as such, advantageously of a curved or angled profile so as to show a first portion adjacent to the main conveyor 4 and showing a limited inclination angle relative thereto (e.g., less than 45°), and a second portion adjacent to the returning element 14 and being horizontal or close to horizontal (e.g., less than 20° inclination relative to horizontal). The loading conveyor 16 can comprise a retractable end 16.2 configured for bringing the food products to one of the at least one outer face 14.1 and 14.2 of the returning element 14. The retractable end 16.2 can be configured for moving in translation from a retracted position where it is located mainly on to the belt conveyor to a deployed position where it is located mainly on the outer face 14.1 or 14.2 of the returning element 14. The loading conveyor 16 can also comprise a scraper 16.3 adjacent to the main conveyor 4 and the entry of the belt conveyor 16.1, arranged for scraping the food products from the main conveyor 4 while it is moving and guiding the food products towards the belt conveyor 16.1.

The returning unit 12 comprises a control unit 17 that is configured for controlling operations of the returning element 14 and the loading conveyor 16, as described here below. The control unit 17 can also belong to the production line 2 and control additional operations like pouring the dough preparation and baking the food products.

In operation, the production line 2 illustrated in FIG. 1 functions as follows. The food products, e.g., the pancakes 10, are poured and baked on the baking plates 6 of the main conveyor, thanks to a pouring unit (not represented) and the burners 8. Once baked on one face, the food products 10 move towards the returning unit 12 where they are collected by the loading conveyor 16 from the main conveyor 4 towards the returning element 14. The food product(s) reaching the end of the loading conveyor 16 is/are transferred to the outer face 14.1 of the returning element 14. The vacuum in the first vacuum chamber 14.4 applied to the aspiration holes 14.3 maintains the food product 10 against the first outer face 14.1 while the returning element 14 is rotated, for instance of 180°, so as to bring the first outer face 14.1 to a lower and returned position, corresponding for instance to the position of the second outer face 14.2 as represented in FIG. 1. Once that position reached, the vacuum in the first vacuum chamber 14.4 is stopped, releasing the food product 10 from the first outer face 14.1 and allow it to fall by gravity back on the main conveyor 4, in a returned stated. The returned side of the food products can then be baked on the baking plates 4.1 by means of the burners 8 located downstream of the returning unit 12.

The relative vacuum pressure is advantageously not greater than 50 mbar, in various instances not greater than 40 mbar, below atmospheric pressure, in particular for pancakes. Depending on the food product, higher vacuum pressures could damage the food product, for instance a pancake, by piercing the food product and extruding the food product material into the aspiration holes, thereby plugging the aspiration holes and losing the sought pressing force of the food product against the corresponding outer face 14.1 or 14.2. This sensibility of the food product to the vacuum pressure depends on the composition of the product and possibly of its baking or cooking grade. Food product made of meat are for example substantially more resistant than bakery products.

Still in operation, while the returning element 14 has rotated, for instance of 180°, for bringing the first outer face 14.1 to a lower position, the second outer face 14.2 is moved to an upper position, corresponding for instance to the initial position of the first outer face 14.1, able to receive another food product while the previous one is returned and at the point to be released. The presence of several outer faces on the returning element 14 allows a higher production rate in that the returning element 14 does not need to bring the otherwise unique outer face back to the upper loading position for loading the next food product(s).

In the exemplary configuration illustrated in FIG. 1 where the returning element 14 shows two opposed outer faces 14.1 and 14.2, the returning element rotates by increments of about 180°. These successive rotations can be in the same rotational direction or alternatively in opposed rotational directions.

FIG. 2 is a perspective view of the returning unit 12 of the production line of FIG. 1. We can observe that the returning unit 12 can extend transversely to the longitudinal direction of the production line, so as to return at the same time several food products of a same row of the production line. In FIG. 2, only two food products are represented in each row, being understood that this can be substantially more.

Still in FIG. 2, we can observe that the retractable end 16.2 of the loading belt conveyor 16.1 comprises a translational sheet or blade configured for being moved, in the retracting movement, along the belt and below the food products 10, and, in the deploying movement, along the corresponding outer face 14.1 of the returning element 14. The blade can show a U-shaped profile with an opening of the U oriented towards the returning element 14. This is advantageous in that once moved to the deployed position on the returning element, the vacuum applied to the aspiration holes presses the central portion of the food product against the corresponding outer face 14.1, so that the blade can moved back to the retracted position while the food product remains in position, avoiding any unwanted movement thereof.

Still in FIG. 2, distinct blades of the retractable end 16.2 are represented being however understood that they are advantageously linked to each other so as to form a single element. Translational means can be provided at the two opposed ends of that single blade element.

As this is apparent in FIG. 2, the returning element 14 shows a polygonal cross-section and in various instances extends along the rotation axis 14.6. The returning element 14 is advantageously a polygonal hollow profile with one or several separation walls between the vacuum chambers associated with the aspiration holes provided in the respective outer faces.

Still with reference to FIG. 2, the aspiration holes 14.3 are arranged in groups along the returning element 14, where each group corresponds to the size of the food product 10. In FIG. 2, each group comprises 9 aspiration holes 14.3 arranged in an array of three rows and three columns. This is merely exemplary. For a circular food product 10 such as a pancake, the aspiration holes in each group can be arranged in concentric circles and not in an array.

FIGS. 3(a)-3(d) show four successive steps of functioning of the returning unit of s FIGS. 1 and 2.

In FIG. 3(a), the food product 10 reaching the end of the loading conveyor 16 is positioned in the retractable end 16.2 in a retracted position. This can be achieved either by a forward movement of the belt of the belt conveyor while the retractable end 16.2 is in the retracted position or by a movement of the retractable end 16.2 from the deployed position back to the retracted position.

In FIG. 3(b), the food product 10 on the retractable end 16.2 is transferred and loaded to the first outer face 14.1 of the returning element 14. In the meantime, the belt conveyor 16.1 can move further so as to advance the next food product.

In FIG. 3(c), vacuum is applied to the first vacuum chamber 14.4 in order to maintain the food product by depression against the first outer face 14.1. The retractable end 16.2 is retracted and thereby moved below the next food product. With reference to the above discussion, the action of bringing the next food product on the retractable end 16.2 in the retracted position can be different form the one considered here. Indeed, alternatively, vacuum can be applied only after retraction of the retractable end 16.2. This can depend on the food product, for instance the extent to which the food product is baked, i.e., how fragile it is. For instance, the food product is baked only partially before being returned and further baked on the other side, meaning that it is potentially fragile at this stage. The retraction speed of the retractable end 16.2 is advantageously of at least 250 mm/s for ensuring a proper retraction where the food product, due it is inertia, remains on the first outer face 14.1 of the returning element 14.

In FIG. 3(d), the returning element 14 is rotated, e.g., clockwise, by about 180° so as to bring the first outer face 14.1 to a lower and returned position, while applying vacuum to the first vacuum chamber 14.4. Once that rotation done, the next food product is transferred and loaded by the retractable end 16.2 to the second outer face 14.2 being now in upper and loading position. Also, the vacuum in the first vacuum chamber 14.4 is released for releasing the food product from the first outer face 14.1 and allowing the food product to be deposited in a returned state on an unloading conveyor being for instance the main conveyor 4.

Important is to note that the returning movement of the food product illustrated in FIG. 3(d) is achieved without any physical retaining means pressing the food product against the corresponding outer face 14.1 or 14.2. In other words, the food product 10 is maintained against the corresponding outer face 14.1 or 14.2 during the returning operation only by virtue of the pressure difference between its outer face and its inner face, due to the vacuum.

After the steps of FIG. 3(d), the steps of FIG. 3(c)-3(d) can be iterated.

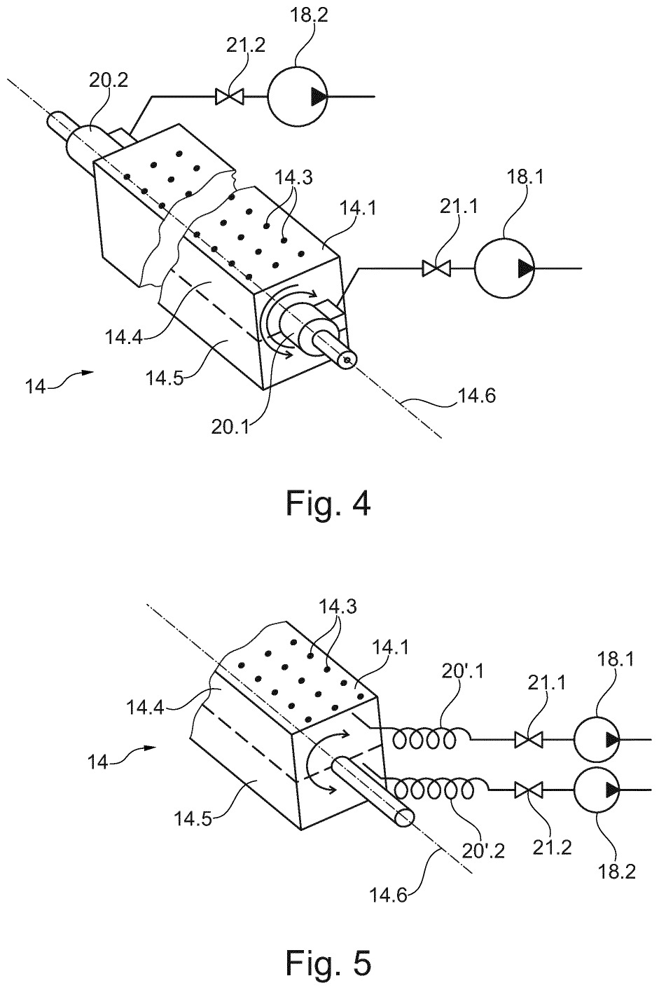

FIG. 4 is a schematic representation of the fluid connection of the returning element to vacuum pumps, according to an embodiment of the invention.

In FIG. 4, the returning element 14 has its two vacuum chambers 14.4 and 14.5 fluidly connected to respective vacuum pumps 18.1 and 18.2. This fluid connection is provided by two rotating joints 20.1 and 20.2 mounted at the opposed ends of the hollow profile forming the returning element 14, along the rotation axis 14.6. Such rotating joints allow a tight fluid connection between a fixed fluid connection and a rotating fluid connection. In the present case, the rotating fluid connection is rigidly fixed with the returning element 14 that is rotatable and is in fluid connection with one of the first and second vacuum chambers 14.4 and 14.5. Shut-off valves 21.1 and 21.2 can be provided fluidly between the rotating joints 20.1 and 20.2 and the respective vacuum pumps 18.1 and 18.2.

With such a rotatable fluid connection, the returning element 14 can rotated in the same rotational direction at every rotation step.

FIG. 5 is a schematic representation of the fluid connection of the returning element to vacuum pumps, according to an alternative embodiment the invention.

Here, the fluid connection between the first and second vacuum chambers 14.4 and 14.5 is via flexible hoses or conduits 20′.1 and 20′.2 which allow the returning element 14 to rotate up to a given angle without damages. This means the in operation the returning element 14 needs to reciprocate, i.e., turn successively in opposed rotational directions.

In FIG. 5, the flexible hoses 20′.1 and 20′.2 are represented schematically as being spiral-shaped, being however understood that other shapes and configuration are possible, e.g., coiled around the rotation axis 14.6.

What is claimed is:

1.-23. (canceled)

24. A unit for returning one or more flat food products, said unit comprising:
a returning element configured for rotating around a rotating axis and provided with at least one outer face for receiving the one or more flat food products to be returned;
wherein the at least one outer face is provided with air aspiration holes for maintaining by depression the one or more flat food products on the outer face when the returning element is rotated with the outer face oriented downwardly; and
a loading conveyor configured for loading the one or more flat food products on one of the at least one outer face of the returning element;
wherein the loading conveyor is a belt conveyor with a retractable end configured for selectively extending from the belt to bring the one or more flat food products from the belt to one of the at least one outer face of the returning element, and retracting to the belt away from the outer face.

25. The unit according to claim 24, wherein each of the at least one outer face is flat.

26. The unit according to claim 24, wherein the at least one outer face comprises a first outer face and a second outer face opposed to the first outer surface.

27. The unit according to claim 24, wherein the at least one outer face comprises more than two outer faces distributed around the rotating axis.

28. The unit according to claim 24, wherein the returning element is elongate along the rotating axis and each of the at least one outer face is subdivided in several areas each for receiving one of the several flat food products.

29. The unit according to claim 24, wherein the returning element comprises a specific vacuum chamber in fluid connection with the air aspiration holes for each of the at least one outer face.

30. The unit according to claim 24, wherein the returning element forms a hollow profile extending along the rotation axis and showing a cross-section with at least one outer wall forming the at least one outer face.

31. The unit according to claim 24, further comprising an unloading conveyor located below the returning element and configured for receiving the one or more flat food products in a returned state.

32. The unit according to claim 31, wherein the unloading conveyor forms a main conveyor extending on an entry side of the unit, the loading conveyor being configured for collecting the one or more flat food products from the main conveyor.

33. The unit according to claim 32, wherein the main conveyor comprises cooking plates attached to each other along a main direction of the main conveyor and configured for receiving along the main direction, each one of the one or more flat food products.

34. The unit according to claim 24, wherein the air aspiration holes on each of the at least one outer face comprise several of the air aspiration holes distributed in a direction perpendicular to the rotating axis for each of the one or more flat food products.

35. The unit according to claim 24, further comprising at least one vacuum pump fluidly connected to the air aspiration holes of the at least one outer face of the returning element.

36. The unit according to claim 35, wherein the fluid connection of the at least one vacuum pump is angularly fixed relative to the returning element, the returning element being actuated for rotating in a reciprocal manner.

37. The unit according to claim 35, wherein the fluid connection of the at least one vacuum pump is angularly rotatable relative to the returning element, the returning element being actuated for rotating in a same rotational direction.

38. The unit according to claim 35, wherein the fluid connection of the at least one vacuum pump is located at one or two ends of the returning element along the rotation axis.

39. The unit according to claim 24, further comprising a control unit configured for, successively and iteratively, bringing one or more of the one or more flat food products on one of the at least one outer face of the returning element, applying a depression to the one or more of the one or more flat food products through the air aspiration holes of the outer face, rotating the returning element so as to return the one or more of the one ore more flat food products, and releasing the depression so that the one or more of the one or more flat food products separate from the returning element by gravity.

40. A process of returning one or more flat food products, said process comprising the steps of:
(a) loading one or more flat food products on an outer surface of a returning element;
(b) rotating the returning element so as to return the one or more flat food products; and
(c) unloading the one or more flat food products from the returning element;
wherein step (b) comprises maintaining the one or more flat food products on the outer face by applying a depression on a lower face of the one or more flat food products via air aspiration holes provided on the outer face; and
wherein step (c) comprises releasing the depression on the one or more flat food products.

41. The process according to claim 40, wherein step (c) further comprises applying compressed air to the air aspiration holes for facilitating releasing of the one or more flat food products from the outer face.

42. The process according to claim 40, wherein the returning element comprises a vacuum chamber in fluid connection with the air aspiration holes on the outer face, and in step (b), a vacuum of not more than 50 mbar below atmospheric pressure is applied in the vacuum chamber for applying the depression.

43. The process according to claim 40, wherein in step (b) the one or more flat food products are maintained on the outer face by the depression only.
